(19) United States
(12) Patent Application Publication
(10) Pub. No.: US 2010/0059314 A1
(43) Pub. Date: Mar. 11, 2010

(54) Inspection Platform

(75) Inventor: Jon Christopher Haines, North Richland Hills, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: C & W Manufacturing and Sales Company, Crowley, TX (US)

(21) Appl. No.: 12/207,348

(22) Filed: Sep. 9, 2008

(51) Int. Cl. E06C 7/16

(52) U.S. Cl. 182/116; 182/223; 182/230

(57) ABSTRACT

An inspection apparatus may include an elevated platform and a drop platform having a first end and a second end, the first end adjacent the elevated platform and operable to be positioned in a raised position and a lowered position. Two or more torsion springs are positioned to engage the drop platform and to keep the drop platform in the raised position when an external force is not applied to the drop platform. Tension of the two or more torsion springs may be individually adjusted.

### FIELD

The present disclosure generally relates to inspection platforms, and relates in particular, but not by limitation, to an inspection platform having one or more individually adjustable torsion springs to raise one or more drop platforms.

### BACKGROUND

The statements in this section merely provide background information related to the present disclosure and may not constitute prior art.

Current inspection platforms for inspecting, for example, slump of wet concrete in a ready mix vehicle have a number of issues. For example, some of today's inspection platforms employ counterweights with shock absorbers to counterbalance drop platforms. In this case, the counterweights have to be galvanized, which is costly and results in variation in their weight. Additionally, the space below the tower must be kept clear to allow free swing of the counterweights. Also, shock absorbers are costly, and have to be replaced periodically. Additionally, many of today's platforms have walking surfaces made of metal, which adds expense in shipping due to weight. Further, need to include counterweights and shock absorbers also increases shipping costs due to weight. Total shipping weight for one such unit is approximately two-thousand seven-hundred pounds.

Another issue with some of today's inspection platforms stems from inability to conveniently ship such inspection platforms because of their size and inability to conveniently assemble and disassemble. Resulting inability to disassemble the tower necessitates shipping of the tower in the assembled state, which adds expense in shipping due to weight and volume. The shipping dimensions for one such unit are approximately one-hundred fifty-nine and one-half inches by sixty-nine inches by fifty inches. Moreover, for multi-lane configuration with two drop platforms, a second tower is required for placement adjacent to the first. Total shipping weight for one such unit having two towers is approximately four-thousand eight-hundred pounds. Such a unit is shipped in two packages, each approximately one-hundred fifty-nine and one-half inches by sixty-nine inches by fifty inches.

### SUMMARY

An inspection apparatus may include an elevated platform and a drop platform having a first end and a second end, the first end adjacent the elevated platform and operable to be positioned in a raised position and a lowered position. Two or more torsion springs are positioned to engage the drop platform and to keep the drop platform in the raised position when an external force is not applied to the drop platform. Tension of the two or more torsion springs may be individually adjusted.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a descending view of a dual unit inspection platform having two drop platforms, in which one of the drop platforms is in a raised position.

FIG. 2 is a descending view of the dual unit inspection platform of FIG. 1, in which the drop platform is in a lowered position.

FIG. 3 is a descending view of a hand railing of the drop platform of FIG. 1 in the raised position.

FIG. 4 is a descending view of a hand railing of the drop platform of FIG. 2 in the lowered position.

FIG. 5 is a perspective view illustrating a safety latch of the drop platform of FIGS. 1-5.

FIG. 6 is a rising view of an inspection platform having a single drop platform in a raised position.

FIG. 7 is a rising view of the inspection platform of FIG. 6 having the drop platform in a lowered position.

FIG. 8 is a rising view of an arrangement of torsion springs, a curved plate, and a hinge coupling the drop platform of FIG. 6 to an elevated platform of the inspection platform.

FIG. 9 is a rising view of an arrangement of torsion springs, a curved plate, and a hinge coupling a drop platform to an elevated platform of an inspection platform.

FIG. 10 is a descending view of the curved plate of FIG. 8 and FIG. 9.

FIG. 11 is a descending view of a tool for adjusting spring tension.

FIG. 12 is a rising view of ends of torsions springs resting against teeth of toothed notches of the curved plate of FIG. 10.

FIG. 13 is a rising view of an arrangement of a ball bearing joint of the hinge of FIG. 8 and FIG. 9, together with a torsion spring having tension adjusted by positioning of its end against a tooth of a toothed notch of the curved plate of FIG. 10 and FIG. 12.

FIG. 14 is a rising view of the curved plate in which a securing plate is employed to secure an end of a torsion spring to the curved plate.

FIG. 15 is a descending view of disassembled components of an inspection platform like those illustrated in FIGS. 1-14, in which stairs, railings, platforms, and supports, are detachably attachable and configured to lie together in a stack when disassembled for shipping.

FIG. 16 is a descending view of the inspection platform of FIG. 7, in which a wash down platform is installed at a position of lower elevation.

FIG. 17 is a descending view of the dual unit inspection platform of FIG. 2, in which a wash down platform is installed at a position of lower elevation.

### DETAILED DESCRIPTION

The following description is merely exemplary in nature and is not intended to limit the present disclosure, application, or uses.

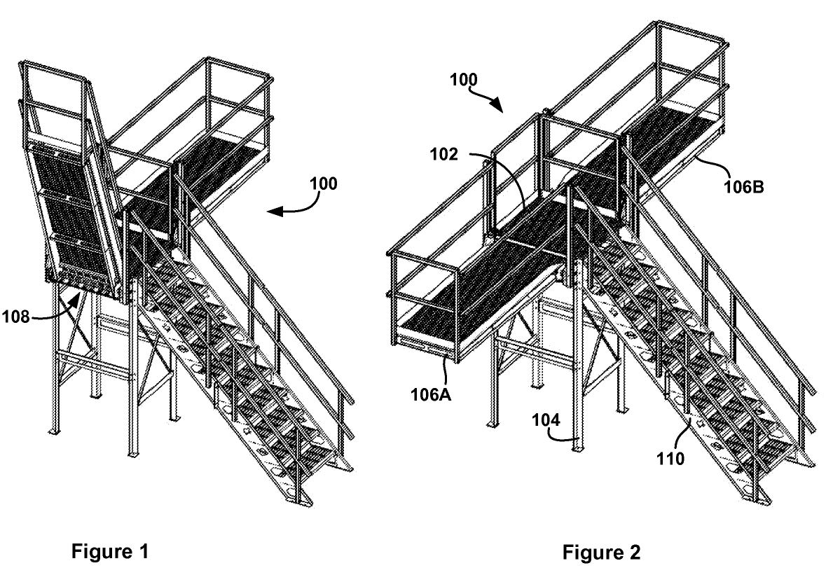

Referring generally to FIGS. 1-5 and FIG. 15-17, an embodiment of a dual unit inspection platform 100 has an elevated platform 102 detachably attached to supports 104. Drop platforms 106A and 106B are hingedly coupled to or positioned adjacent to opposite sides of the elevated platform 102. An array of torsion springs 108 engaged with the drop platforms 106A and 106B provide a force to raise the drop platforms 106A and 106B when the drop platforms are transitioning from a lowered position, such as the drop platform 106A shown in FIG. 2, to a raised position, such as that shown in FIG. 1. The array of torsion springs 108 are used to automatically return the platforms 106A and 106B to raised positions when the weight or force exerted by the user is not present on the drop platforms 106A and 106B.

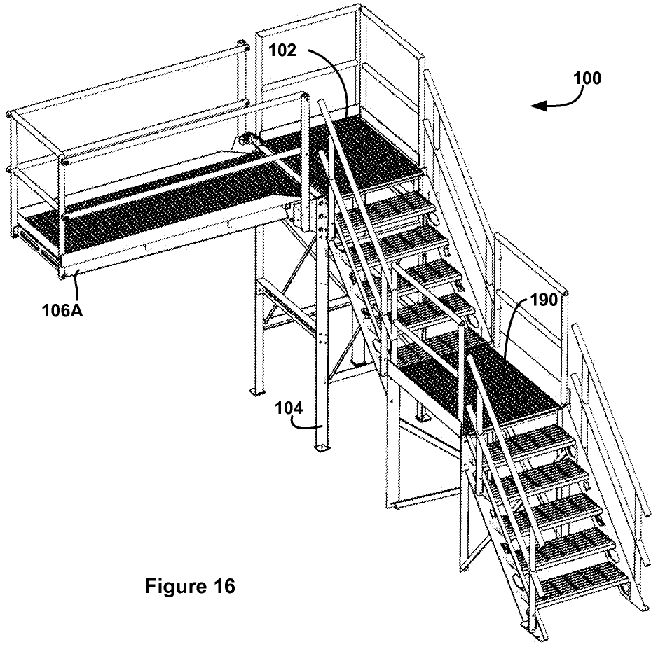

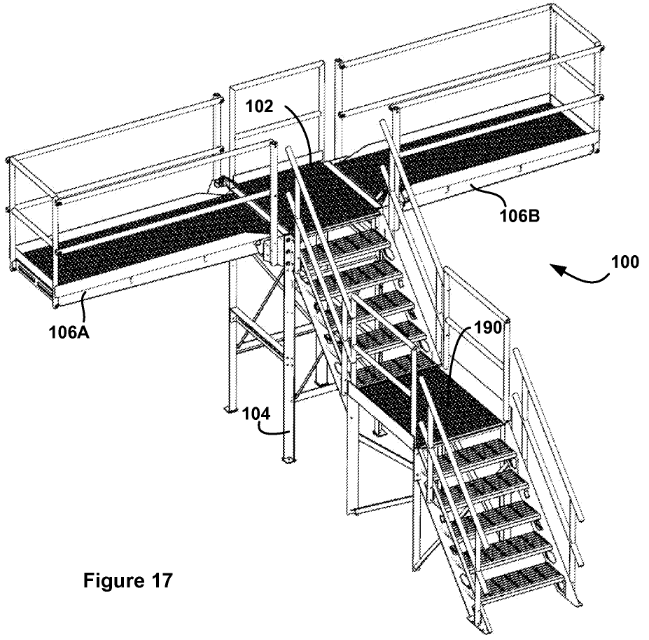

In some embodiments, stairs 110 shown detachably attached to the elevated platform 102 allow personnel to access elevated platform 102 from ground level. In some embodiments, the stairs are composed of stair supports detachably attachable to the elevated platform. Steps and railings, in certain embodiments, are detachably attachable to the stair supports. The stair supports and the railings are divided into two portions in some embodiments. These portions may be detachably attachable (FIGS. 16-17) to another elevated platform (e.g., wash down platform 190) of height lower than the elevated platform to which the drop platform may be detachably attached in certain embodiments. The addition of the wash down platform assists personnel in washing down a vehicle, such as a ready-mix truck.

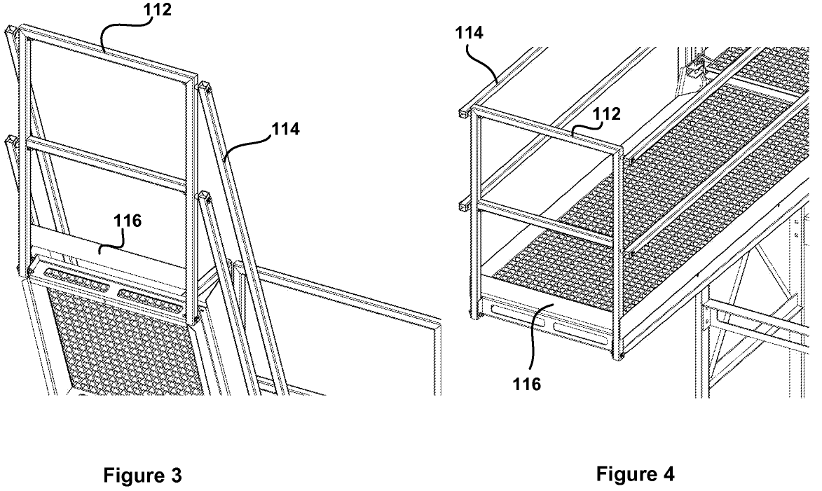

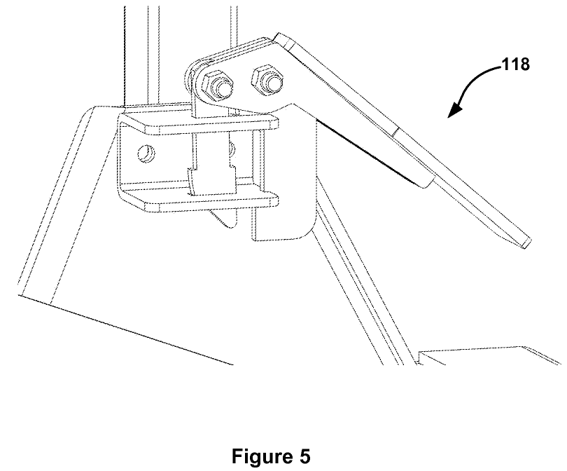

In some embodiments, such as that shown in FIGS. 3 and 4, an end hand railing component 112 of the drop platform is hinged to the drop platform and other railing members. It is hinged in such a manner that side hand railing components 114, which are also hinged, can be hinged to the end hand railing component 112 so as not to protrude through the end hand railing component 112 when the drop platform is in raised position. It is envisioned that the end hand railing component 112 has a kick plate 116 that is fixed to the end hand rail component 112, in one embodiment, rather than to the drop platform. This arrangement eliminates friction points, which eases the operation of the drop platform in the absence of counterweights. In some embodiments, a tipper latch locking mechanism 118 (FIG. 5) is useful for locking the drop platform in a raised position. In other embodiments, the kick plate 116 may be coupled to or integrated as part of the drop platform.

There are a number of considerations to be noted in regard to various embodiments of the inspection platform 100. For example, there are no counterweights that have to be galvanized in some embodiments, which avoids cost and resulting variation in their weight. Also, shock absorbers do not have to be attached to an underside of the elevated platform 102 to intercept or counteract the force of the counterweights. Thus the expense of providing and replacing such shock absorbers may be avoided in some embodiments, but shock absorbers could be integrated if desired. Further, in some embodiments the platform walking surfaces are made of fiberglass grating, which avoids expense in shipping due to weight. These gratings provide excellent grip surfaces for footing, and can have upper surfaces that are concave and/or impregnated with sand for improved grip. Additionally, avoiding the need to include counterweights and shock absorbers also decreases shipping costs due to weight. Total shipping weight for one embodiment of these units with a single drop platform is approximately one-thousand two-hundred pounds, while the approximate shipping weight of a unit having two drop platforms is one-thousand eight-hundred pounds.

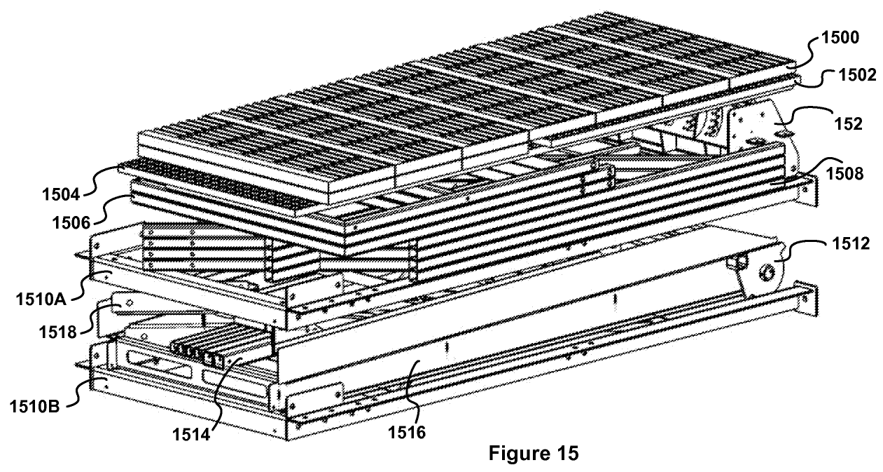

The detachability of the supports 104 to the elevated platform 102, in certain embodiments, allows shipping of the tower in a disassembled state (FIG. 15), which avoids expense in shipping due to size, in some embodiments. For similar reasons, in a preferred embodiment, all components of the inspection platform, including stairs, railings, platforms, and supports, are detachably attachable and configured to lie together in a stack when disassembled for shipping in some embodiments. For example, individual step gratings 1500 can be arranged atop elevated platform grating 1502 and drop platform grating 1504. Drop platform railings 1506 can be stacked atop stair railings 1508, adjacent curved plate 152. These components can lie atop supports 1510A and 1510B, which have other components sandwiched there between. These other components can include hinge 1512, support braces 1514, drop platform frame 1516, and stair supports 1518.

In one embodiment, the shipping dimensions for such a unit having a single drop platform are approximately ninety-six and one-half inches by forty-three and one-quarter inches by forty-seven and one-half inches. Additionally, space below the tower need not be kept clear to allow free swing of the counterweights, which frees space for use as storage. Moreover, elimination of the counterweights and shock absorbers allows multiple drop platforms to be positioned adjacent or attached to the same elevated platform for multi-lane configuration. In other words, no second tower is required for placement adjacent to the first. In one embodiment, the shipping dimensions for such a unit having a two drop platforms are approximately ninety-six and one-half inches by sixty-one inches by forty-seven and one-half inches.

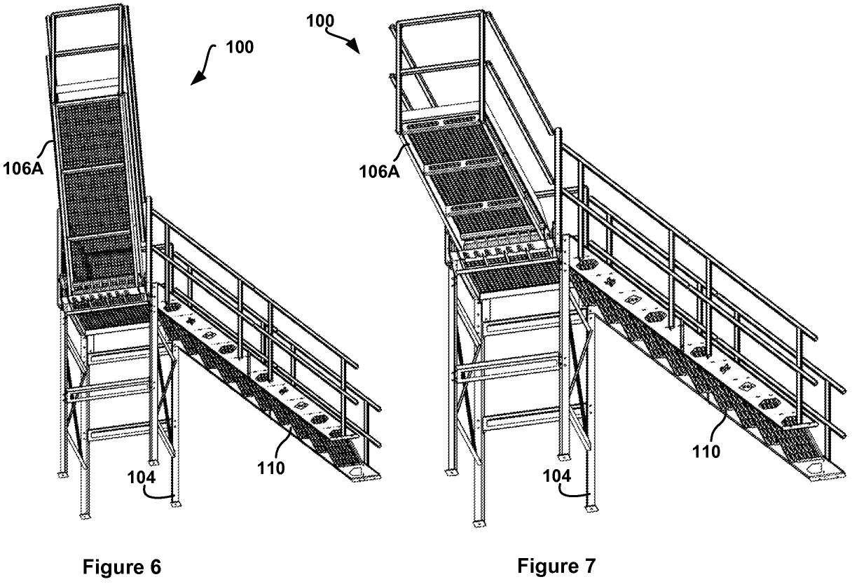

FIGS. 6-7 illustrate an inspection platform 100 having a single drop platform 106A placed adjacent to elevated platform 102. This single drop platform 106A can move from a raised position (see FIG. 6) to a lowered position (see FIG. 7). As a user's needs grow, a second drop platform, such as drop platform 106B of FIG. 2, may be added without the need to include an additional elevated platform. In certain embodiments, each drop platform has its own array of individually adjustable torsion springs 108. Thus, torsional force effect of each array can be adjusted independently of the other in these embodiments.

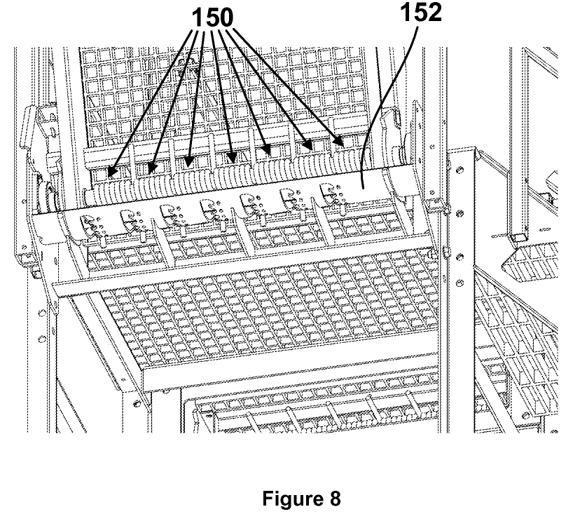

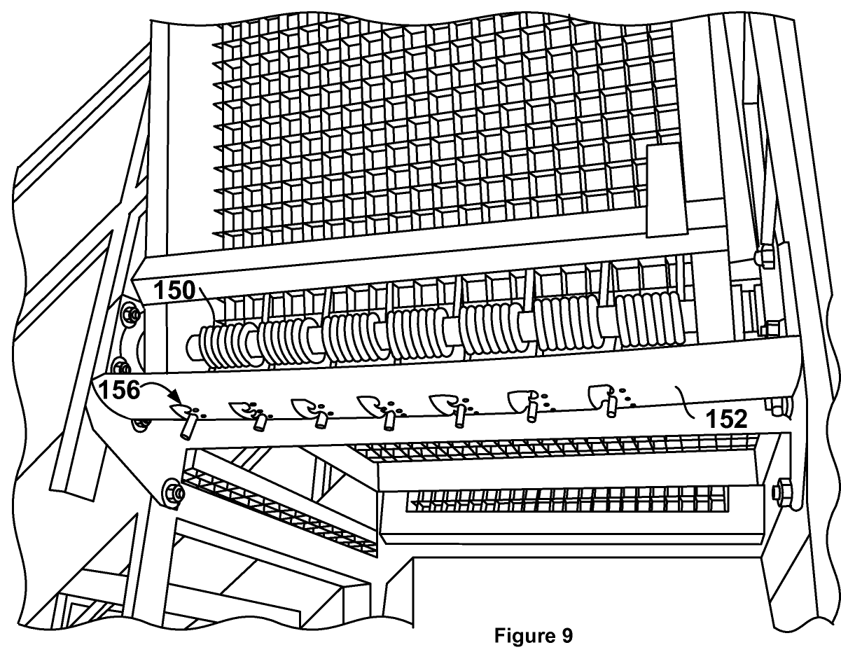

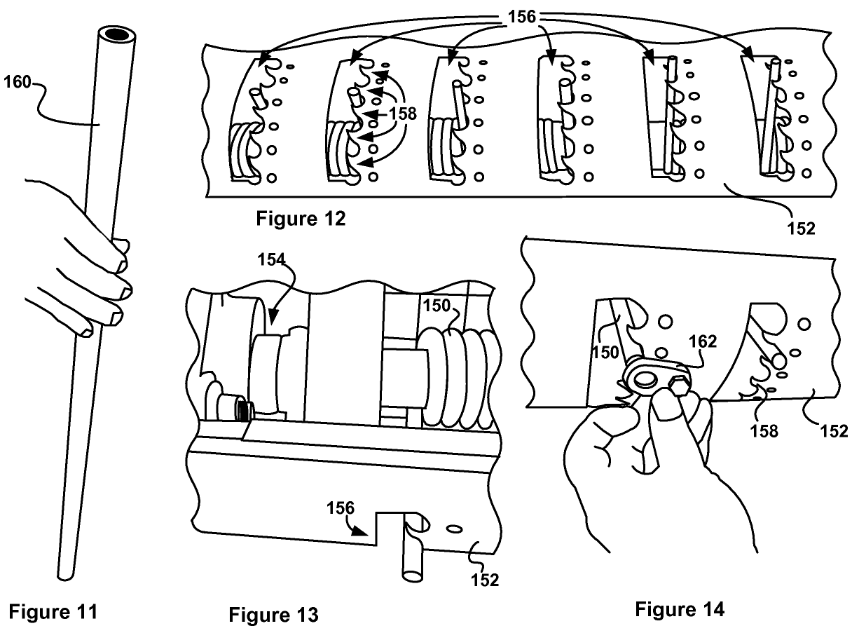

Turning now to FIGS. 8-14 and referring generally thereto, the automatic repositioning of the drop platform is accomplished by an arrangement of torsion springs 150 having individually adjustable tension. In some embodiments, these torsion springs 150 engage the hinge coupling the drop platform to the elevated platform. In some embodiments, a ball bearing hinge 154 is employed (FIG. 13). In other embodiments, the torsion springs are mechanically engaged to raise the drop platform, and may or may not couple directly to the elevated platform.

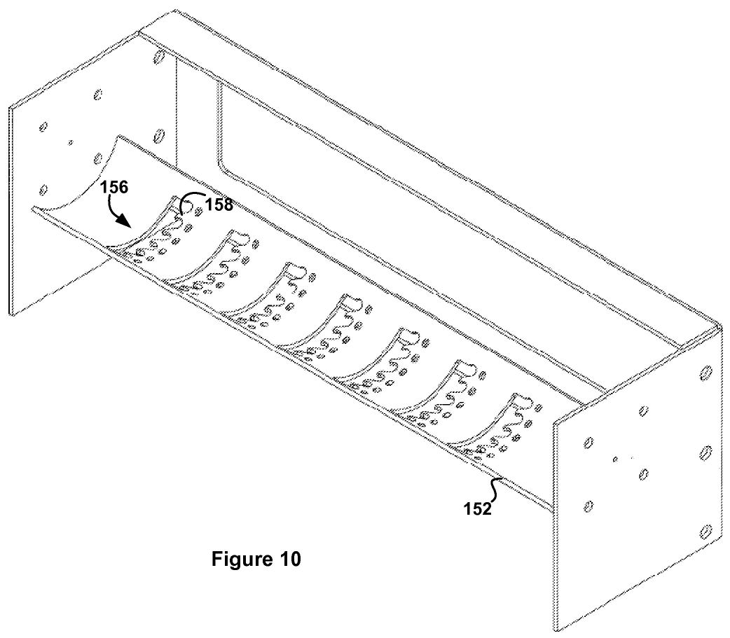

In some embodiments, a member, such as a curved plate 152 (FIG. 10) having a cylindrical surface, is positioned to receive ends of the springs 150. In one embodiment, the curved plated 152 may be attached to the elevated platform, or some other support structure. In one embodiment, the plate 152, which may be curved or flat, has a curved diameter of approximately eight inches. It is envisioned that a flat plate can be employed in other embodiments, and that members having other shapes and/or configurations can be used.

The plate 152 has a plurality of toothed notches 156 sized and shaped for one end of each of the torsion springs 150 to pass through the notches 156 and rest against the teeth 158. Each spring 150 passes through one notch 156 and rests against one of the teeth. The notches 156 extend in a tension adjusting direction, and tension of a spring 150 can be set by selecting a tooth 158 of the notch 156 against which the end of that spring shall rest. In some embodiments, there are seven notches each having five teeth that provide for six adjustment positions per spring.

In some embodiments, a tool 160 is provided for use by personnel in adjusting individual spring tension. This tool 160 can be a length of pipe having an opening of suitable diameter for engaging the ends of the springs, and a length suitable for reaching the ends of the springs with the pipe from a position standing at ground level beside the supports. By engaging an end of the tool 160 with an end of a spring 150, personnel can pry the end of the spring 150 out from beside one of the teeth 158, and move the end of the spring 150 into position next to another of the teeth 158 within the notch 156.

In some embodiments, the teeth 158 are shaped with convex and concave sides to facilitate repositioning and retention of the ends of the springs 150. Securing plates 162 can also be used to attach the ends of the springs to the plate 152 in their selected positions in some embodiments. For example, an ovular plate having two through holes formed therein can be slid over an end of a spring 150 at one through hole, and a bolt can be passed through the other through hole and another through hole formed in the plate 152. Thus, arrays of through holes can be formed in the plate 152 next to the notches and extending alongside the notches to facilitate use of the securing plates. It should be understood that the ends of each torsion spring 150 may be placed on different teeth within the respective notches to provide a desired overall tension in the plurality of torsion springs 150.

In use, personnel can employ the inspection platform by first standing on the elevated platform, and applying a force to the drop platform to overcome the tension of torsion springs to move the drop platform from the raised position to the lowered position. The personnel can then walk on an upper surface of the drop platform from the first end towards the second end and inspect the contents in a vehicle, such as, for example, a ready-mix truck or rail car. Personnel can then walk from the drop platform to the elevated platform, thereby removing the force and permitting the torsion springs to return the drop platform to the raised position. When desired, personnel can adjust the tension on the torsion springs individually in the manner described above.

What is claimed is:

1. An inspection apparatus, comprising:
an elevated platform;
a drop platform having a first end and a second end, the first end positioned adjacent the elevated platform and operable to be positioned in a raised position and a lowered position; and
two or more torsion springs positioned to engage the drop platform and to keep the drop platform in the raised position when an external force is not applied to the drop platform, and wherein tension of the two or more torsion springs may be individually adjusted.

2. The apparatus of claim 1, further comprising:
a curved member having a plurality of toothed notches formed therein and each tooth adapted to receive an end of one of the two or more torsion springs, wherein positioning of the end against a tooth of a notch affects the tension on the torsion spring.

3. The apparatus of claim 1, further comprising:
a member having a plurality of toothed notches formed therein and each tooth adapted to receive an end of one of the two or more torsion springs, wherein positioning of the end against a tooth of a notch affects the tension on the torsion spring.

4. The apparatus of claim 3, further comprising:
an adjustment tool operable to position an end of one of the two or more torsion springs from a first tooth of the curved member to a second tooth of the curved member.

5. The apparatus of claim 4, wherein the adjustment tool is a pipe.

6. The apparatus of claim 2, further comprising:
a securing coupling adapted to couple the end of one of the two or more torsion springs to the curved member and thereby secure the end in position adjacent one of the teeth.

7. The apparatus of claim 1, wherein the drop platform is coupled to the elevated platform.

8. The apparatus of claim 1, further comprising:
railings coupled to the elevated platform and the drop platform.

9. The apparatus of claim 1, further comprising:
stair supports positioned adjacent to the elevated platform;
steps coupled between the stair supports; and
railings positioned above the stair supports.

10. The apparatus of claim 9, wherein the stair supports and the railings are divided into two portions that are detachably attachable to a second elevated platform of position lower than the elevated platform.

11. The apparatus of claim 1, wherein platform walking surfaces, including at least one of a surface of the elevated platform and a surface of the drop platform, are formed of fiberglass grating.

12. The apparatus of claim 11, wherein upwardly facing surfaces of the fiberglass grating are concave.

13. The apparatus of claim 11, wherein at least a portion of the surfaces are impregnated with sand.

14. The apparatus of claim 1, further comprising a second drop platform positioned adjacent a second side of the elevated platform.

15. The apparatus of claim 1, wherein the drop platform is coupled to the elevated platform using a hinged arrangement that includes a ball bearing hinge.

16. The apparatus of claim 1, further comprising:
a latch locking mechanism adapted to lock the drop platform in the raised position.

17. The apparatus of claim 1, wherein the elevated platform, the drop platform, and the two or more torsion springs are detachably attachable and configured to lie together in a stack when disassembled for shipping.

18. An inspection apparatus, comprising:
an elevated platform;
a drop platform having a first end and a second end, the first end positioned adjacent the elevated platform and operable to be positioned in a raised position and a lowered position;
two or more torsion springs positioned to engage the drop platform and to keep the drop platform in the raised position when an external force is not applied to the drop platform, and wherein tension of the two or more torsion springs may be individually adjusted;
a member having a plurality of toothed notches formed therein and two or more teeth adapted to receive an end of one of the two or more torsion springs, wherein positioning of the end against a tooth of a notch affects the tension on the torsion spring;
a securing coupling adapted to couple the end of one of the two or more torsion springs to the member; and
stairs positioned adjacent the elevated platform and operable to extend from a first level to the elevated platform.

19. A method for using an inspection apparatus that includes an elevated platform, a drop platform having a first end positioned adjacent the elevated platform, the drop platform operable to be positioned in a raised position and a lowered position, and two or more torsion springs under tension and positioned to engage the drop platform and to keep the drop platform in the raised position when an external force is not applied to the drop platform, the method comprising:
standing on the elevated platform;
applying a force to the drop platform to overcome the tension of the two or more torsion springs to move the drop platform from the raised position to the lowered position;
walking on an upper surface of the drop platform from the first end towards the second end;
inspecting the contents of a vehicle; and
walking from the drop platform to the elevated platform, thereby removing the force and permitting the torsion springs to return the drop platform to the raised position.

20. The method of claim 19, wherein the vehicle is a truck.

21. The method of claim 19, wherein the vehicle is a ready-mix truck.

22. The method of claim 19, wherein the vehicle is a rail car.

23. The method of claim 19, further comprising:
individually adjusting the tension on at least one of the two or more torsion springs.
